(19) United States
(12) Patent Application Publication
(10) Pub. No.: US 2015/0364826 A1
(43) Pub. Date: Dec. 17, 2015

(54) INVERTED-F ANTENNA AND VEHICLE-MOUNTED COMPOSITE ANTENNA DEVICE

(71) Applicant: HARADA INDUSTRY CO., LTD., Tokyo (JP)

(72) Inventor: Shigeki KUDO, Tokyo (JP)

(21) Appl. No.: 14/832,207

(22) Filed: Aug. 21, 2015

Related U.S. Application Data
(63) Continuation of application No. PCT/JP2014/054382, filed on Feb. 24, 2014.

(30) Foreign Application Priority Data
Feb. 22, 2013 (JP) 2013-033021

(51) Int. Cl. H01Q 9/04

(52) U.S. Cl. CPC H01Q 9/0421

(57) ABSTRACT

An inverted-F antenna includes a ground member, a first antenna member including a short-circuit portion rising perpendicularly from the ground member while being electrically coupled with the ground member, a flat plate portion extending from a top end of the short-circuit portion while being electrically coupled with the short-circuit portion, and a protrusion portion protruding from a part of an end of the flat plate portion; and a second antenna member including a conductor pattern that includes a power supply portion at one end portion thereof, has a width increasing toward an opposite end, and is electrically coupled with the flat plate portion. The second antenna member is located between the ground member and the flat plate portion with a predetermined distance from an end of the flat plate portion opposite to the protrusion portion.

### CROSS REFERENCE TO RELATED APPLICATIONS

This application is based upon and claims the benefit of priority from the prior Japanese Patent Application No. 2013-033021, filed on Feb. 22, 2013 and the PCT Patent Application No. PCT/JP2014/054382, filed on Feb. 24, 2014, the entire contents of which are incorporated herein by reference.

### FIELD

The present invention relates to an inverted-F antenna that is compatible to a wide band, has a simple structure and is produced at low cost, also to and a vehicle-mounted composite antenna device including such an inverted-F antenna.

### BACKGROUND

An inverted-F antenna is compact, easy to produce, and produced at relatively low cost, and therefore is widely used for a mobile communication device such as a mobile phone or the like.

Recently, antennas for mobile phones have been desired to have a function of sharing multiple frequency bands, and antennas having an inverted-F antenna as a fundamental element have been proposed. For example, Japanese Patent No. 4169696 discloses an inverted-F antenna including a metal member electrically connected to a ground member such as a ground plate or the like of the inverted-F antenna, and an additional metal member that is separated from the first metal member by a slot having such a size that allows capacitance coupling of the metal members. This inverted-F antenna has a structure in which a signal feed line is supplied to the additional metal member.

Japanese Patent No. 3630622 has an object of providing a compact wide-band patterned antenna including a patterned antenna that is patterned on the surface of, or inside, a substrate. This patterned antenna is provided on the substrate including a power supply line and a ground conductor. The patterned antenna disclosed by Japanese Patent No. 3630622 includes a ground conductor on each of surfaces of the substrate, a first antenna pattern of an inverted-F shape, and a second antenna pattern of an inverted-L shape. The first antenna pattern is provided on a first surface of the substrate, and includes a ground conductor pattern and a power supply conductor pattern. The second antenna pattern is provided on a second surface of the substrate, and includes a ground conductor pattern. At least one of the antenna patterns has a trapezoidal shape.

Japanese Laid-Open Patent Publication No. 2004-128740 has an object of providing a compact and low-cost multi-frequency antenna that is compatible to two or more frequency bands, namely, multiple frequency bands. Japanese Laid-Open Patent Publication No. 2004-128740 discloses a radiation electrode element including a single frequency band radiation electrode, and a second radiation electrode extending from an electrode end of the single frequency band radiation electrode. The second radiation electrode extends so as to make a U-turn from the electrode end toward an end opposite to the electrode end.

### SUMMARY

An inverted-F antenna in an embodiment according to the present invention includes a ground member, a first antenna member including a short-circuit portion rising perpendicularly from the ground member while being electrically coupled with the ground member, a flat plate portion extending parallel to the ground member from a top end of the short-circuit portion while being electrically coupled with the short-circuit portion, and a protrusion portion located in the same horizontal plane as that of the flat plate portion and extending in a direction perpendicular to a longitudinal direction of the flat plate portion; and a second antenna member including a conductor pattern, the conductor pattern including a power supply portion at one end portion thereof, having a width increasing toward an opposite end, and being electrically coupled with the flat plate portion. The second antenna member is located between the ground member and the flat plate portion with a predetermined distance from an end of the flat plate portion opposite to the protrusion portion. Namely, as seen in a plan view, the conductor pattern is located in an area of the flat plate portion so as to be directly coupled or capacitance-coupled with the flat plate portion at such a degree that a signal received by the flat plate portion or the protrusion portion flows to the conductor pattern, while the conductor pattern being electrically insulated from the ground member.

In the inverted-F antenna in an embodiment according to the present invention, the ground member, the short-circuit portion and the flat plate portion may be formed of one conductive plate.

In the inverted-F antenna in an embodiment according to the present invention, at least one of the ground member, the short-circuit portion and the flat plate portion may include a securing portion securing the second antenna member at a predetermined position.

In the inverted-F antenna in an embodiment according to the present invention, the second antenna member may be a rectangular substrate and may be secured to the securing portion.

A vehicle-mounted composite antenna device in an embodiment according to the present invention includes the inverted-F antenna having any of the above-described structures; and an antenna unit receiving radio waves from a satellite. The antenna unit is mounted outside the protrusion portion and the flat plate portion, in the vicinity of ends of the protrusion portion and the flat plate portion.

### BRIEF DESCRIPTION OF THE DRAWINGS

FIG. 1A is a side view of an inverted-F antenna in an embodiment according to the present invention;

FIG. 1B is a plan view of the inverted-F antenna in an embodiment according to the present invention;

FIG. 1C is a front view of the inverted-F antenna in an embodiment according to the present invention;

FIG. 2 is a front view of the inverted-F antenna in an embodiment according to the present invention;

FIG. 3A is a graph showing characteristics of a vehicle-mounted composite antenna device in an embodiment according to the present invention in a low frequency band (810 to 960 MHz);

FIG. 3B a graph showing characteristics of a vehicle-mounted composite antenna device in an embodiment according to the present invention in a high frequency band (1710 to 2170 MHz);

FIG. 4A is an exploded perspective view of the vehicle-mounted composite antenna device in an embodiment according to the present invention as seen obliquely from a position above and to the front thereof;

FIG. 4B is an exploded perspective view of the vehicle-mounted composite antenna device in an embodiment according to the present invention as seen obliquely from a position below and to the rear thereof;

FIG. 5 is a schematic cross-sectional view of the vehicle-mounted composite antenna device in an embodiment according to the present invention;

FIG. 6A is a graph showing characteristics of an inverted-F antenna in an embodiment according to the present invention in the low frequency band (810 to 960 MHz); and

FIG. 6B is a graph showing characteristics of an inverted-F antenna in an embodiment according to the present invention in the high frequency band (1710 to 2170 MHz).

### DESCRIPTION OF EMBODIMENTS

In the case where the Inverted-F antenna as described in Patent Document 1 Japanese Patent No. 4169696, the patterned antenna as described in Patent Document 2 Japanese Patent No. 3630622, or the radiation electrode element as described in Patent Document 3 Japanese Laid-Open Patent Publication No. 2004-128740 is used as a vehicle-mounted antenna device, there are restrictions on the size of the space inside the vehicle, the position and the attachment position of the antenna device, and the like. This causes a problem that desired characteristics are not provided, and there is a limit on the size reduction.

A GSM/W-CDMA-compatible model needs to be compatible to, roughly, a low frequency band (810 to 960 MHz) and a high frequency band (1710 MHz to 2170 MHz). An antenna device having a conventional structure has a problem of not providing desired characteristics in all the frequency bands.

In light of these problems, the present invention has an object of providing an inverted-F antenna that is compatible to a wide frequency band, has a simple structure, is produced at low cost, and is sufficiently compatible to the restrictions on the size of the space inside the vehicle, the position and the attachment position of the antenna, and the like.

Hereinafter, an embodiment of the present invention will be described with reference to the drawings.

An antenna according to the present invention is designed to be operable in two or three frequency bands. An example of the antenna according to the present invention is a multi-band telephone antenna operable in a band of 890 to 960 MHz, a band of 1710 to 1880 MHz and a band of 1920 to 2175 MHz

The antenna according to the present invention is compatible to the GSM (Global System for Mobile Communication) (registered trademark), which is a wireless access system of the second-generation wireless telephone technology (2G), and also to the W-CDMA (Wideband Code Division Multiple Access), which is a wireless access system of the third-generation wireless telephone technology (3G).

### [Multi-Band Antenna]

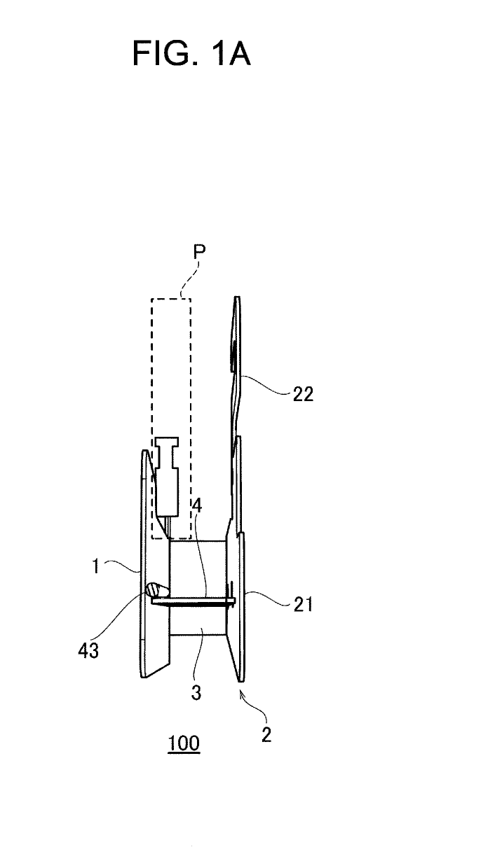

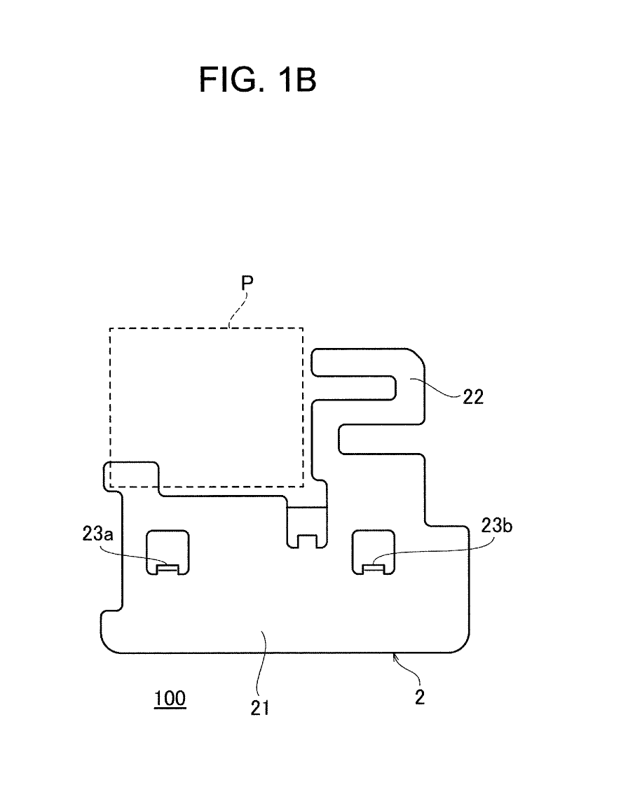

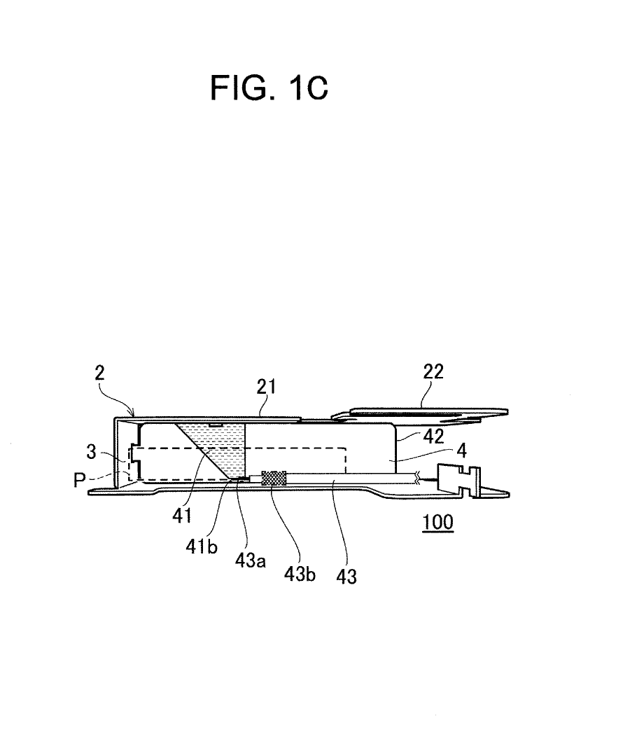

As shown in FIG. 1A, an inverted-F antenna 100 in embodiment 1 includes a conductive ground member 1 and a first antenna member 2 including an integral body of a flat plate portion 21 and a short-circuit portion 3. In this embodiment, the ground member 1, the flat plate portion 21 and the short-circuit portion 3 are formed of a single metal plate by molding so as not to be separated. Alternatively, the ground member 1, the flat plate portion 21 and the short-circuit portion 3 may be formed as separate components and made conductive to each other via a metal conductor cable or the like. Still alternatively, the ground member 1, the flat plate portion 21 and the short-circuit portion 3 may be integrally formed with a second antenna member.

As shown in FIG. 1A, the ground member 1 and the flat plate portion 21 are each formed to be plate-like. The flat plate portion 21 extends from a top end of the short-circuit portion 3 horizontally to the ground member 21, and the second antenna member 24 described later is provided between the flat plate portion 21 and the ground member 1.

In the vicinity of an end of the flat plate portion 21 that is opposite to a connection portion with the short-circuit portion 3, a protrusion portion 22 extending in a direction perpendicular to a longitudinal direction of the flat plate portion 21 is provided. The flat plate portion 21 and the protrusion portion 22 are provided on the same horizontal plane and are away from the ground member 1 by substantially the same distance.

The protrusion portion 22 is a part of an antenna that transmits and receives a first-frequency wireless signal. As seen in a plan view of FIG. 1B, the protrusion portion 22 extends from the vicinity of one end of the flat plate portion 21 and makes turns in a meandering manner in an area which does not cover a patch antenna unit P. In FIG. 1A through FIG. 1C, the dotted-line frame schematically represents the size and the position of the patch antenna unit P as compared with the inverted-F antenna 100.

In order to secure the second antenna member 4, the flat plate portion 21 may have substrate securing portions 23a and 23b formed thereon. The substrate securing portions 23a and 23b may each be formed by folding a part of the flat plate portion 21 and act as a regulating piece at a position where the second antenna member 4 is to be secured. Alternatively, the substrate securing portions 23a and 23b may each be formed by providing a convexed regulating piece formed of a resin or the like at a position where the second antenna member 4 is to be secured, instead of by folding a part of the flat plate portion 21. Still alternatively, the substrate securing portions 23a and 23b may each be formed of an adhesive applied to a position where the second antenna member 4 is to be secured.

The second antenna member 4 has substantially the same height as that of the short-circuit portion 3, and is provided between the ground member 1 and the flat plate portion 21 so as to be perpendicular to each of the ground member 1, the flat plate portion 21 and the short-circuit portion 3. The second antenna member 4 includes an insulating substrate 42 formed of glass epoxy or the like and a conductor pattern 41 formed on a surface thereof.

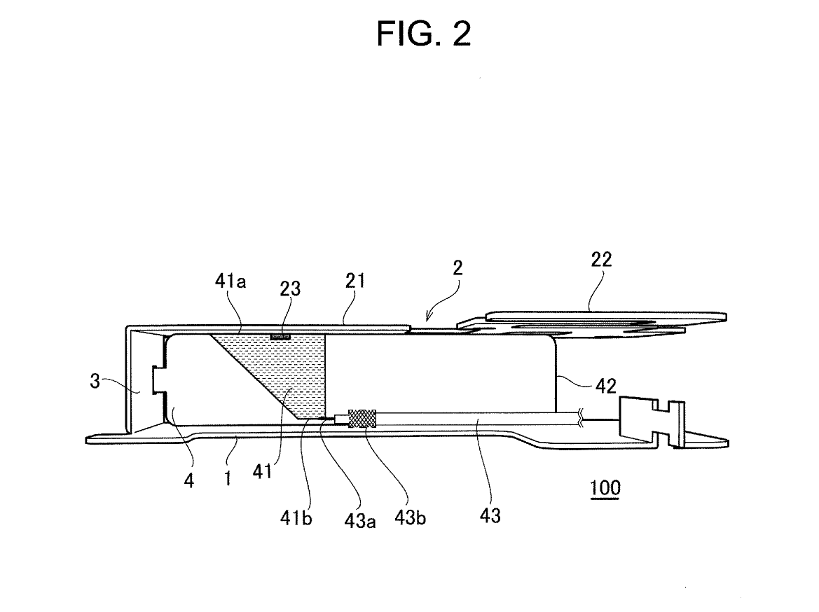

The conductor pattern 41 includes a top end portion 41a substantially parallel to, and close to, the flat plate portion 21, and a power supply portion 41b substantially parallel to, and close to, the ground member 1 and shorter than the top end portion 41a. The power supply portion 41b is connected to a core wire 43a of a coaxial cable 43, and a ground wire 43b of the coaxial cable 43 is in contact with the ground member 1. As shown in FIG. 2, in this embodiment, the conductor pattern 41 is soldered to the flat plate portion 21 in a connection portion 23. There is no specific limitation on the length of the soldered area or the length of an electrical contact area. It is sufficient that the conductor pattern 41 is electrically coupled with the flat plate portion 21. Therefore, the conductor pattern 41 and the flat plate portion 21 may be located close to each other such that the flat plate portion 21 and the top end portion 41a are in capacitance coupling in the state where the second antenna member 4 is secured, instead of the conductor pattern 41 and the flat plate portion 21 being connected to each other by soldering.

It is sufficient that the top end portion 41a of the conductor pattern 41 is electrically coupled with the flat plate portion 21, and there is no specific limitation on the shape of the top end portion 41a. For example, only one part of the top end portion 41a may be connected to the flat plate portion 21 by soldering or the like, whereas the rest of the top end portion 41a may be out of contact with the flat plate portion 21.

The conductor pattern 41 is provided at such a position that is electrically insulated from the ground member 1, and is connected to the coaxial cable 43 as shown in FIG. 2.

In order to improve the gain characteristics of the inverted-F antenna 100, it is preferable that the conductor pattern 41 is formed such that the top end portion 41a is longer than the power supply portion 41b. For this purpose, the conductor pattern 41 is formed to be generally trapezoidal in this embodiment. The conductor pattern 41 is not limited to being generally trapezoidal and may have any other shape as long as the top end portion 41a is longer than the power supply portion 41b. For example, the power supply portion 41b may have a minimum possible size with which electrical connection with the coaxial cable 43 is guaranteed.

The top end portion 41a and the power supply portion 41b may each be located just below the protrusion portion 22 as seen in a plan view of the protrusion portion 22, or may each be located outer to the protrusion portion 22 as seen in a plan view of the protrusion portion 22. The top end portion 41a and the power supply portion 41b are each provided at a position away from an end of the flat plate portion 21 by a predetermined distance as seen in a plan view of the second antenna member 4. The position of the power supply portion 41b is determined in consideration of the frequency band of a signal that is to be received by the inverted-F antenna 100.

### [Vehicle-Mounted Composite Antenna Device]

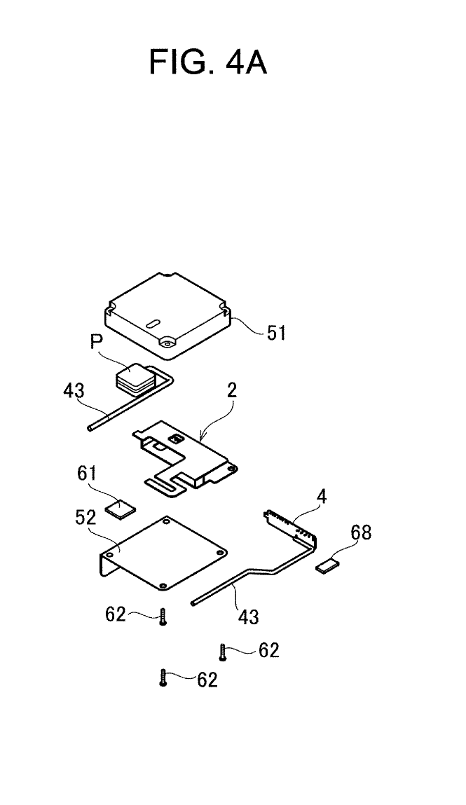

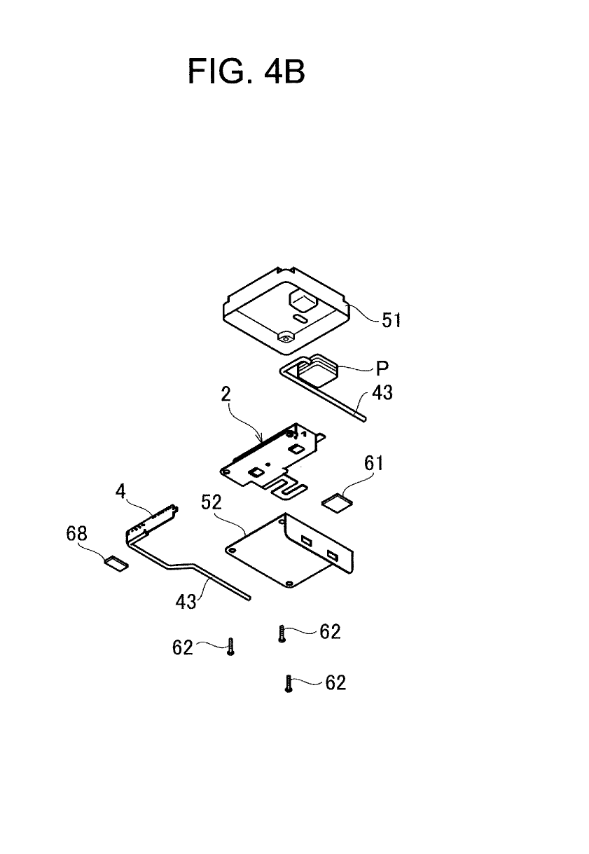

The inverted-F antenna 100 may be located close to an antenna unit that receives radio waves from a satellite such as a GPS satellite or the like. Even in the case where the inverted-F antenna 100 is located at such a position, transmission or receiving of a signal by the inverted-F antenna 100 is not prevented, and at least substantially the same level of effect is provided as in the case where such a GPS antenna is not provided. FIG. 4A and FIG. 4B are each an exploded perspective view of a vehicle-mounted composite antenna device in this embodiment including the inverted-F antenna 100 and the patch antenna unit P that receives radio waves from a GPS satellite.

The vehicle-mounted composite antenna device in this embodiment includes an outer frame 51 such that the patch antenna unit P receiving radio waves from a satellite such as a GPS satellite, and the inverted-F antenna 100, are each located at a position shown in FIG. 1A through FIG. 1C.

The vehicle-mounted composite antenna device in this embodiment may be assembled as shown in FIG. 4A and FIG. 4B. First, the inverted-F antenna 100 is secured onto a base 52 by use of a securing tool such as a screw 62 or the like. Then, the patch antenna unit P is secured onto the base 52 by use of an adhesive cushioning member 61 so as to be close to the inverted-F antenna 100.

The inverted-F antenna 100 and the patch antenna unit P are covered with the outer frame 51. After the position of the outer frame 51 is determined, the outer frame 51 is secured onto the base 52 by use of a securing tool such as a screw 62 or the like.

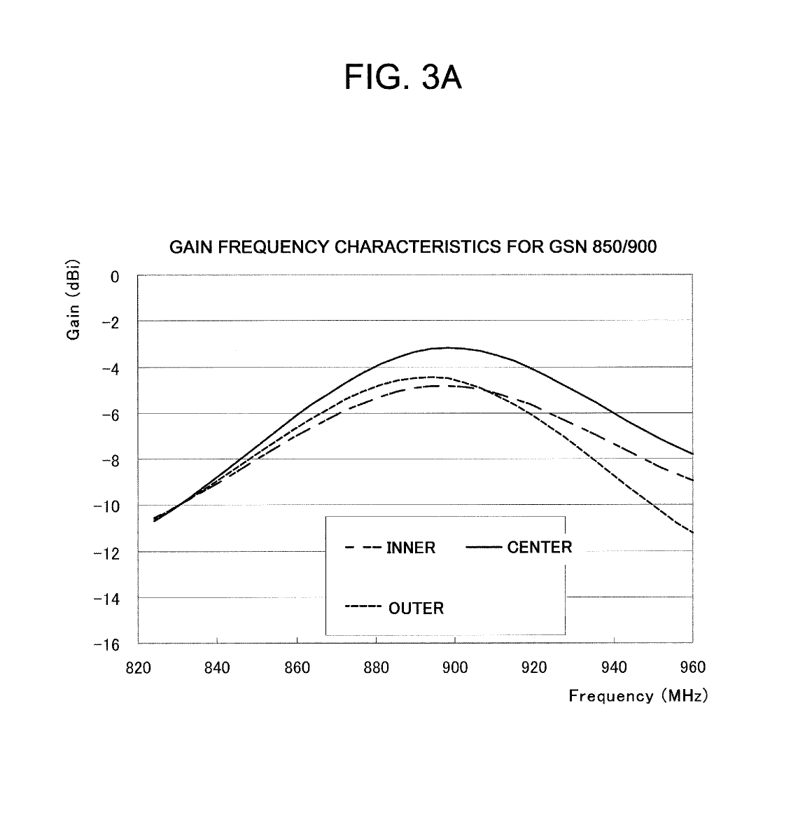

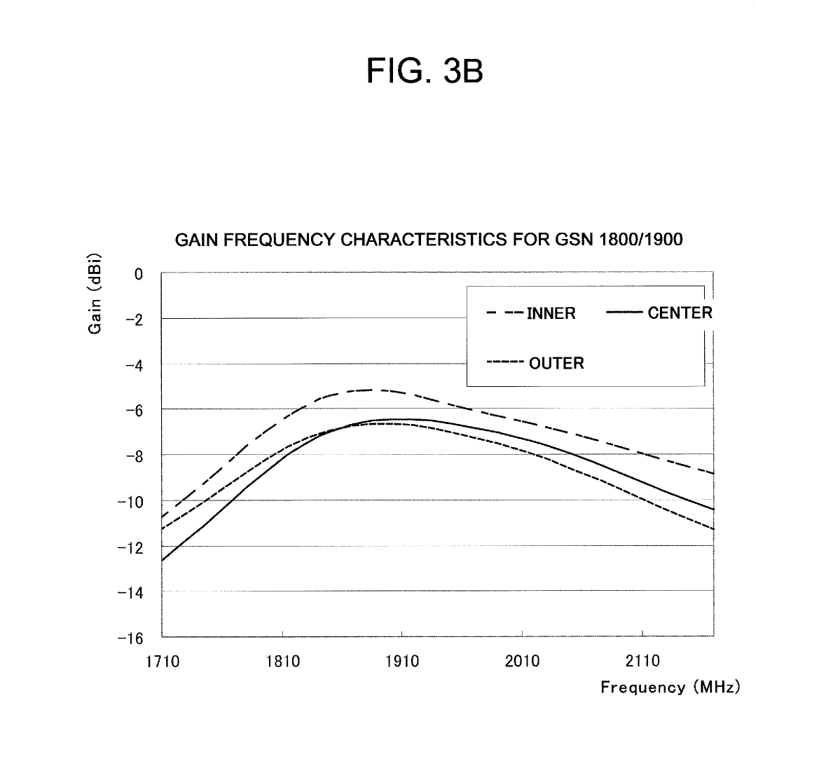

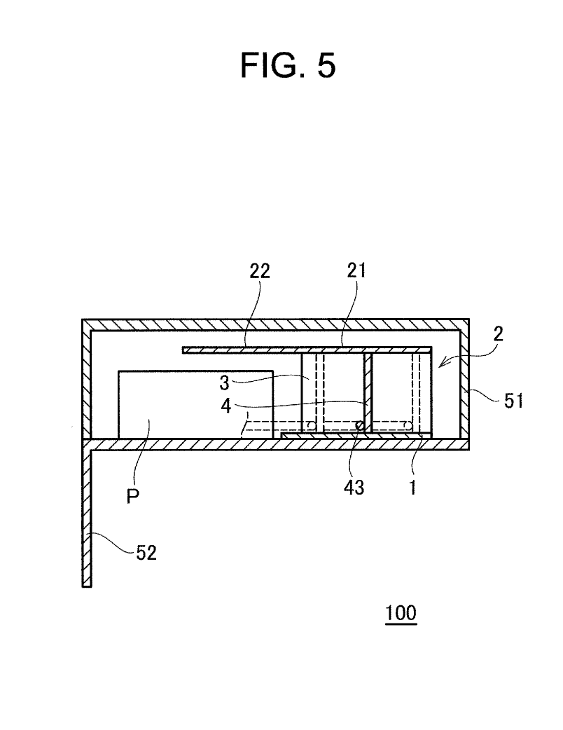

FIG. 3A is a graph showing characteristics of the vehicle-mounted composite antenna device in this embodiment shown in FIG. 5 in the low frequency band (820 to 960 MHz). FIG. 3B is a graph showing characteristics thereof in the high frequency band (1710 to 2170 MHz). In the inverted-F antenna having the structure in this embodiment, as shown in FIG. 2, the top end portion 41a and the flat plate portion 21 are directly coupled to each other by soldering.

In each of FIG. 3A and FIG. 3B, an “inner” curve shows a characteristic of the second antenna member 4 in the case where the second antenna member 4 is located at a position, in the area just below the flat plate portion 21, that is closest to the patch antenna unit P. In each of FIG. 3A and FIG. 3B, a “central” curve shows a characteristic of the second antenna member 4 in the case where the second antenna member 4 is located at a position shown in FIG. 5 with the solid line, namely, at substantially the central position between the two ends of the flat plate portion 21. In each of FIG. 3A and FIG. 3B, an “outer” curve shows a characteristic of the second antenna member 4 in the case where the second antenna member 4 is located at a position, in the area just below the flat plate portion 21, that is farthest from the patch antenna unit P.

In each of FIG. 3A and FIG. 3B, the “inner” and “central” curves each show the characteristic of the second antenna member 4 in the case where the second antenna member 4 is located between the ground member 4 and the flat plate portion 21 with a predetermined distance from an end of the flat plate portion 21 that is opposite to the protrusion portion 22 (hereinafter, this end will also be referred to as the “outer end of the flat plate portion 21”).

By contrast, in each of FIG. 3A and FIG. 3B, the “outer” curve shows the characteristic of the second antenna member 4 in the case where the second antenna member 4 is located between the ground member 4 and the flat plate portion 21, at the outer end of the flat plate portion 21.

The graph of FIG. 3A shows that in the low frequency band (820 to 960 MHz), the frequency characteristic of the “central” curve is higher than that of the “inner” curve; whereas the frequency characteristics become gradually closer to each other as the frequency increases from about 890 MHz. Regarding the “outer” curve, the following is seen: as the frequency increases from about 890 MHz, the “outer” curve inclines downward more largely; and at a point in the vicinity of about 910 MHz, the frequency characteristic of the “outer” curve becomes lower than the frequency characteristics of the other curves, and the difference thereof with those of the “inner” and “central” curves increases after this point.

The graph of FIG. 3B shows the following: in the frequency band of 1710 to about 1860 MHz, the frequency characteristic of the “outer” curve is higher than that of the “central” curve; at a point in the vicinity of about 1860 MHz, the frequency characteristic of the “outer” curve becomes lower than the frequency characteristics of the other curves; and as the frequency increases from about 1890 MHz, the “outer” curve inclines downward more largely, and the difference thereof with those of the “inner” and “central” curves gradually increases after this point.

As is seen from the graphs of FIG. 3A and FIG. 3B, the frequency characteristic of the “outer” curve is higher than those of the “central” or “inner” curve in a part of the frequency band, but has a strong tendency of being declined after a predetermined frequency. By contrast, in the case where the second antenna member 4 is located between the ground member 1 and the first antenna member 2 with a predetermined distance from the outer end of the flat plate portion 21, as compared with the case where the second antenna member 4 is located at the outer end of the flat plate portion 21, the frequency characteristics exhibit a tendency of being decreased, and therefore it is seen that the performance is superior.

As shown in the graphs of FIG. 3A and FIG. 3B, the “central” curve has a higher frequency characteristic than that of the “inner” curve in the low frequency band (810 to 960 MHz), whereas the “inner” curve has a higher frequency characteristic than that of the “central” curve in the high frequency band (1710 to 2170 MHz). Therefore, in accordance with the frequency band to be prioritized, the second antenna member 4 may be located at an appropriate position in the area just below the flat plate portion 21 except for the outer end of the flat plate portion 21. In this manner, the characteristic in the frequency band to be prioritized may be adjusted without significantly spoiling the characteristic in a frequency band other than the frequency band to be prioritized.

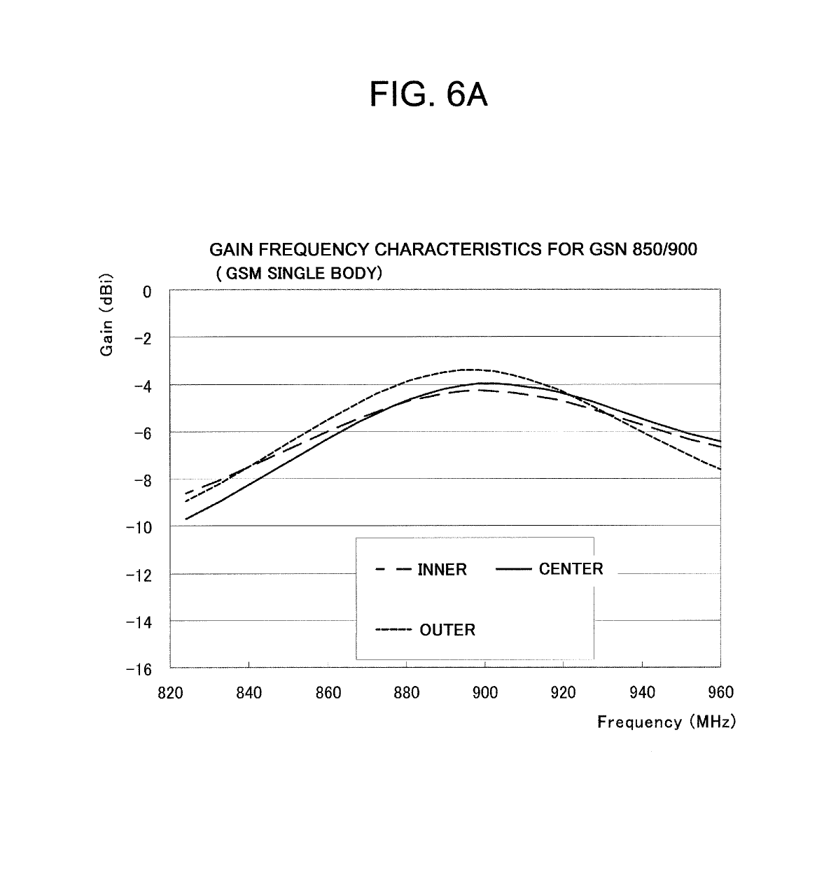

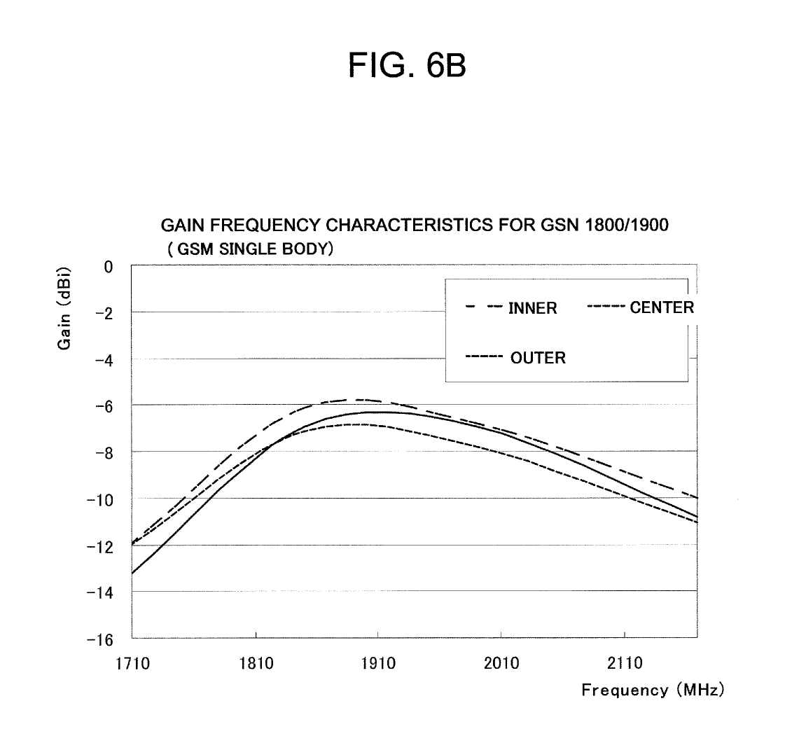

FIG. 6A and FIG. 6B respectively show results of measurement of frequency characteristics of a single-body phone antenna device in the low frequency band (810 to 960 MHz) and the high frequency band (1710 to 2170 MHz). The single-body phone antenna device has substantially the same structure as that shown in FIG. 5 except that the patch antenna unit P is detached from the vehicle-mounted composite antenna device in this embodiment shown in FIG. 5.

FIG. 3B and FIG. 6B will be compared with each other. FIG. 3B and FIG. 6B are common to each other in that in a frequency band between 1800 MHz to 1900 MHz excluding 1900 MHz, the frequency characteristic of the “outer” curve becomes lower than that of the “central” curve so as to be lower than those of the other curves.

A comparison between FIG. 3A and FIG. 6A shows the following. In a frequency band from about 830 MHz to about 930 MHz, the frequency characteristics of the “central”, “inner” and “outer” curves are close to each other, namely, have substantially the same frequency characteristics. As the frequency is increased from about 890 MHz, the “outer” curve inclines downward more largely. At a frequency higher than about 900 MHz, the frequency characteristic of the “outer” curve becomes lower than those of the other curves, and the difference thereof from those of the “inner” and “central” curves increases.

According to FIG. 3B and FIG. 6B, in the high frequency band (1710 to 2170 MHz), the frequency characteristic of the “inner” curve is higher than that of the “central” curve. However, the characteristics of both of the curves are superior to the frequency characteristic of the “outer” curve at, and higher than, a frequency between 1800 MHz and 1900 MHz excluding 1900 MHz. In comprehensive consideration of the results shown in FIG. 3A, FIG. 3B, FIG. 6A and FIG. 6B, the second antenna member 4 provides a better performance when being located at a position, in the area just below the flat plate portion 21, that is other than the outer end of the flat plate portion 21.

In the case where the second antenna member 4 is located between the ground member 1 and the flat plate portion 21, at a position other than the outer end of the flat plate portion 21, the performance of the second antenna member 4 does not significantly change in the low frequency band (810 to 960 MHz). Therefore, in accordance with the frequency band to be prioritized on the high frequency band side, the second antenna member 4 may be located at an appropriate position, in the area just below the flat plate portion 21, that is other than the end of the flat plate portion 21 farthest from the patch antenna unit P, namely, that is other than the outer end of the flat plate portion 21. In this manner, the characteristic in the frequency band to be prioritized may be adjusted.

How much the second antenna member 4 is to be moved inward from the outer end of the flat plate portion 21 may be adjusted in accordance with the frequency as a target. In this case, the characteristic of the frequency band to be prioritized may be adjusted without significantly spoiling the characteristic in a frequency band other than the frequency band to be prioritized.

The inverted-F antenna in an embodiment according to the present invention provides good characteristics while having a low height. In the case where the position of the second antenna member is moved, the characteristic in a high frequency band may be improved while the characteristic in the low frequency band may be maintained.

The vehicle-mounted composite antenna device in an embodiment according to the present invention, even in the case where an antenna for a mobile phone and an antenna for the GPS are integrated together, provides the same effect as in the case where the antenna for the GPS is not included, without transmission or receiving of signals by the antenna for the mobile phone is prevented. In addition, in accordance with the position of the second antenna member, fine tuning suitable to the desired frequency is possible.

What is claimed is:

1. An inverted-F antenna, comprising:
a ground member;
a first antenna member including a short-circuit portion rising perpendicularly from the ground member while being electrically coupled with the ground member, a flat plate portion extending parallel to the ground member from a top end of the short-circuit portion while being electrically coupled with the short-circuit portion, and a protrusion portion located in the same horizontal plane as that of the flat plate portion and extending in a direction perpendicular to a longitudinal direction of the flat plate portion;
a second antenna member including a conductor pattern, the conductor pattern including a power supply portion at one end portion thereof, having a width increasing toward an opposite end, and being electrically coupled with the flat plate portion; and
the second antenna member is located between the ground member and the flat plate portion with a predetermined distance from an end of the flat plate portion opposite to the protrusion portion.

2. The inverted-F antenna according to claim 1, wherein the ground member, the short-circuit portion and the flat plate portion are formed of one conductive plate.

3. The inverted-F antenna according to claim 1, wherein at least one of the ground member, the short-circuit portion and the flat plate portion includes a securing portion securing the second antenna member at a predetermined position.

4. The inverted-F antenna according to claim 3, wherein the second antenna member is a rectangular substrate and is secured to the securing portion.

5. A vehicle-mounted composite antenna device comprising:
an inverted-F antenna including:
a ground member;
a first antenna member including a short-circuit portion rising perpendicularly from the ground member while being electrically coupled with the ground member, a flat plate portion extending parallel to the ground member from a top end of the short-circuit portion while being electrically coupled with the short-circuit portion, and a protrusion portion located in the same horizontal plane with the flat plate portion and extending in a direction perpendicular to a longitudinal direction of the flat plate portion; and
a second antenna member including a conductor pattern, the conductor pattern including a power supply portion at one end portion thereof, having a width increasing toward an opposite end, and being electrically coupled with the flat plate portion, and the second antenna member is located between the ground member and the flat plate portion with a predetermined distance from an end of the flat plate portion opposite to the protrusion end; and
an antenna unit receiving radio waves from a satellite, and the antenna unit is mounted outside the protrusion portion and the flat plate portion, in the vicinity of ends of the protrusion portion and the flat plate portion.

6. The vehicle-mounted composite antenna device according to claim 5, wherein the ground member, the short-circuit portion and the flat plate portion are formed of one conductive plate.

7. The vehicle-mounted composite antenna device according to claim 5, wherein at least one of the ground member, the short-circuit portion and the flat plate portion includes a securing portion securing the second antenna member at a predetermined position.

8. The vehicle-mounted composite antenna device antenna according to claim 7, wherein the second antenna member is a rectangular substrate and is secured to the securing portion.
